(19) United States
(12) Patent Application Publication
(10) Pub. No.: US 2021/0123541 A1
(43) Pub. Date: Apr. 29, 2021

(54) Valve Key

(71) Applicant: South East Water Corporation, Frankston, Victoria (AU)

(72) Inventors: Ronald Peters, Frankston, Victoria (AU); Andrew Forster-Knight, Frankston, Victoria (AU); Juan Londono, Frankston, Victoria (AU)

(73) Assignee: South East Water Corporation, Frankston, Victoria (AU)

(21) Appl. No.: 16/973,808

(22) PCT Filed: May 27, 2019
(86) PCT No.: PCT/AU2019/050520

§ 371 Date: Dec. 10, 2020

(30) Foreign Application Priority Data
Jun. 29, 2018 (AU) 2018902365

(51) Int. Cl. F16K 31/60; F16K 37/00; H04W 4/70; H04W 4/80; G01S 19/05

(52) U.S. Cl. CPC F16K 31/607; F16K 37/0025; F16K 37/0075; F16K 31/50; H04W 4/80; G01S 19/05; H04W 4/70

(57) ABSTRACT

A valve key for operating a fluid control valve between states, the valve key comprising a body having a key portion configured for operating a correspondingly keyed part of the fluid control valve; a telemetry system and comprising sensors configured to output parameters relating to an orientation and a rotational movement of the body; a location-positioning module configured to receive data from GPS; a communications module for transmitting data; and a controller configured to determine one or more of for the key: an orientation between substantially vertical or horizontal positions, a number of rotations and geographical coordinates, wherein the controller is configured such that the telemetry system is set to a low-power state, and set to an operating state, in which the telemetry system modules and the controller are configured to record the number of rotations, when the body is oriented in substantially vertical or horizontal positions.

### FIELD OF THE INVENTION

The invention relates to a valve key for operating valves, and more specifically an improved valve key capable of actuating and recording the operational states of a pipeline valve.

### BACKGROUND

In the utilities business, the problem of not knowing the true status of a manually-operated valve is universal. Contractors and operational teams for a utilities business may operate fluid valves, for the purpose of controlling fluid flows, rectifying pipeline network failures and planned fluid diversion works, by mounting a steel valve key to, for example, a pipeline fluid control valve and rotating the key numerous times until the valve is in the desired open, partially open or closed state. Once such a valve is actuated for any reason, it is either left in that state or arranged to be returned to its original state at a later time—which requires the valve operator to remember which of the numerous valves have been changed. Information regarding the actual states of actuated valves often becomes misreported or lost, thereby causing affected valves to be left in an undesired state by field operators.

Conventional valve keys may be provided with sensors to record the number of key turns with respect to a valve, but the drawback is that an electronic hardware, which interfaces with the sensors of such valve keys, would need to be installed at each valve location—a process which can be expensive and time-consuming to implement for a large network of valves. Similarly, conventional remote controlled automated valves also require the installation of expensive hardware which is fixed to each valve location and such costs limit the use of automated valves in a network such as a reticulated water system. Another drawback for conventional valve keys fitted with sensors is that field operators are typically required to activate the sensors of the valve key and synchronise the sensors with the corresponding electronic hardware of the pipeline valve with a local computer (such as a smart phone) and further operations of a related software application (such as a smart phone application) would be required before recordal of the status of the valve on the local computer can be made; these cumbersome steps are time consuming and could lead to unintended operational errors. Furthermore, valve keys fitted with electronic sensors would need to be provided with a portable power source in the form of a battery, which if not deactivated properly after each use could lead to premature depletion of power and result in a non-functioning valve key with unpowered electronic sensors when it is to be used in the field.

The applicant has determined that it would be advantageous to provide a valve key for actuating fluid control valves with improved reliability and useability. The present invention, in its preferred embodiments, seeks to at least in part alleviate some of the above-identified problems.

### SUMMARY OF THE INVENTION

According to an aspect of the present invention, there is provided a valve key for operating a fluid control valve between open and closed states, the valve key comprising a body having a key portion configured for operating a correspondingly keyed part of the fluid control valve; a telemetry system operatively coupled to the body, the telemetry system comprising one or more sensors configured to output parameters relating to an orientation and a rotational movement of the body; a location-positioning module configured to receive data from global positioning satellites; a communications module for transmitting data to a remote server; and a controller configured to determine an orientation of the key between a substantially horizontal position and a substantially vertical position, a number of rotations of the key with respect to its longitudinal axis when the key portion is coupled to the fluid control valve and geographical coordinates relating to a location of the key from the output parameters and the satellite data, wherein the controller is configured such that the telemetry system is set to a low-power state when the body is oriented in a substantially horizontal position, and set to an operating state, in which the telemetry system modules and the controller are configured to record the number of rotations of the key, when the body is oriented in a substantially vertical position.

Preferably, the telemetry system is configured to be a standalone module that is removable from the body.

Preferably, the key further comprises a detachable handle bar configured to be slideably receivable in a corresponding cavity located at an end opposing an end associated with the key portion of the body.

Preferably, the cavity is provided with a sensor configured to output parameters relating to a presence of the handle bar relative to the cavity, and wherein the controller is configured to determine the presence of the handle bar in the cavity from the output parameters of said sensor and set the telemetry system to the operating state when the handle bar is received within the cavity.

Preferably, the telemetry system further comprises a storage module for retaining data relating to the number of rotations of the key with respect to its longitudinal axis and the geographical coordinates of the key.

Preferably, the controller is configured to operate the communications module to send data relating to the number of rotations of the key with respect to its longitudinal axis and the geographical coordinates of the key to a remote server.

Preferably, the controller is configured to operate the communications module to send said data relating to the number of rotations of the key with respect to its longitudinal axis and the geographical coordinates of the key when the body is oriented in a substantially horizontal position and the communications module is placed in a low-powered mode once data transmission to the remote server is complete.

Preferably, the controller is configured to output said data to a local computing device.

Preferably, the controller is configured to start determining the number of rotations of the key with respect to its longitudinal axis when the controller receives instructions from a remote server.

Alternatively, the controller is configured to start determining the number of rotations of the key with respect to its longitudinal axis when the controller receives instructions from a local computing device.

Preferably, the controller is configured to start determining the number of rotations of the key with respect to its longitudinal axis when a sensor detects that the key portion is engaged with a receiving portion of a fluid control valve.

Preferably, the controller is configured to retrieve a previously recorded status of a fluid control valve from a remote server based on comparing the geographical coordinates relating to the location of the key with a database of geographical coordinates of fluid control valves within a network.

Preferably, the controller is configured to retrieve a previously recorded status of a fluid control valve from a local computing device based on the geographical coordinates relating to the location of the key.

Preferably, the sensor configured to output parameters relating to the rotational movement of the body is also placed in a low-powered mode when the telemetry system is set to the suspended state.

Preferably, the communications module comprises a cellular telecommunications radio. Preferably, the cellular telecommunications radio is a Narrowband Low Power Wide Area Network (NBIoT) radio. Preferably, the communications module is configured to operate over a Lightweight Machine-to-Machine (LWM2M) protocol.

Preferably, the location-positioning module is configured to receive data from multiple global positioning satellite constellations.

Preferably, the body is elongated. Preferably, the keyed part is a socket.

Preferably, the telemetry system is further provided with a display unit configured for displaying information relating to any one of the following non-limiting outputs (1) name and status of a fluid control valve, (2) geographical location of the key, (3) a number of rotations of the key with respect to its longitudinal axis when the key portion is coupled to the fluid control valve, and (4) connection status with respect to a local computing device or a remote server.

According to another aspect of the present invention, there is provided a valve key for operating a fluid control valve between open and closed states, the valve key comprising a body having a key portion configured for operating a correspondingly keyed part of the fluid control valve; a telemetry system operatively coupled to the body, the telemetry system comprising one or more sensors configured to output parameters relating to a rotational movement of the body; a location-positioning module configured to receive data from global positioning satellites; a communications module for transmitting data to a remote server; and a controller configured to determine a number of rotations of the key with respect to its longitudinal axis when the key portion is coupled to the fluid control valve and geographical coordinates relating to a location of the key from the output parameters and the satellite data.

According to another aspect of the present invention, there is provided a system for managing the status of a fluid control valve which is configurable between open and closed states, comprising a valve key as described above and a remote server configured to receive information from the telemetry system of the valve key relating to a geographical location of the key and a number of rotations of the key with respect to its longitudinal axis when the key portion is coupled to the fluid control valve, and storing said information in a database against a record for said fluid control valve which is retrievable by the valve key when positioned in proximity to the fluid control valve.

Further aspects of the present invention and further embodiments of the aspects described in the preceding paragraphs will become apparent from the following description.

### DESCRIPTION OF THE DRAWINGS

The invention will now be described, by way of non-limiting examples only, with reference to the accompanying drawings, in which:

FIG. 1 is a schematic perspective view of a valve key in accordance with a preferred embodiment of the present invention;

FIG. 2 is a schematic view of an assembled valve key in accordance with the preferred embodiment of the present invention;

FIG. 3 is a schematic view of a partial valve key and a handle bar in accordance with the preferred embodiment of the present invention;

FIG. 4 is a schematic view of a system for managing the status of a valve in accordance with a preferred embodiment of the present invention; and

FIG. 5 is a conceptual diagram of a telemetry system in accordance with an embodiment of the present invention.

### DETAILED DESCRIPTION

Embodiments of the present invention relate to a valve key capable of actuating and recording the operational states of a fluid control valve, and to systems employing such valve keys. While embodiments of the valve key and system will be described below for use with pipeline and fluid control valves in the non-limiting example of a water distribution system, it is to be understood by a skilled person that embodiments of the valve key and systems employing such valve keys are equally suitable for use with other valves that would benefit from having their operational statuses recorded. Non-limiting examples of suitable valves include oil and gas pipeline valves and any other fluid-carrying pipeline valves. The term “fluid” will be understood in the specification to include liquid fluid and gaseous fluid, unless the context requires otherwise.

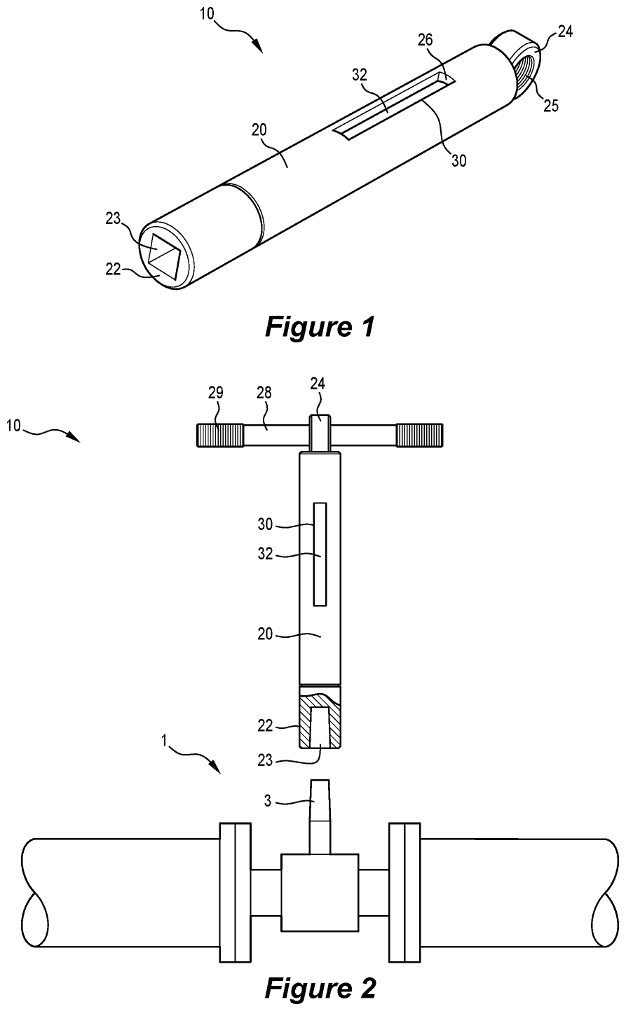

With reference to FIGS. 1 to 3, a valve key 10 for operating a fluid control valve 1 has a body 20 having a first end 22, which is configured to operatively couple with the fluid control valve 1, and a second end 24, opposing the first end 22, configured for detachably coupling with a handle bar 28, which is actuated in use by a field operator for turning the valve key 10. Turning the valve key 10 when it is operatively coupled to the fluid control valve 1 would effect a movement of the valve control mechanism such that the valve is operated between its open, partially open and closed states. The valve key 10 is provided with a telemetry system 30 configured for collecting information relating to the valve key 10 and the status of the fluid control valve 1 and transmitting said information to a remote server 50 and/or a local computing device 52.

In the preferred embodiment, the valve key 10 is configured in a modular form such that the body 20 and the handle bar 28 are separable, when not in use, to facilitate easier handling as well as improved storage and portability; this is owing to the body 20 and the handle bar 28 being able to be more optimally stored in a parallel arrangement when disassembled. In one embodiment, the second end 22 of the body is configured with a key portion 23 for interfacing with a correspondingly keyed part 3 of the fluid control valve 1. In some arrangement, the key portion 23 is a recess configured to match the shape of a corresponding projection of the keyed part 3 of the fluid control valve 1, such that rotational movement of the valve key body 20 with respect to the key axis (for example, this could also be the body's 20 longitudinal axis) will effect movement of the keyed part 3 of the fluid control valve 1 and accordingly operate the fluid control valve 1 between open, partially open and closed states. In some configurations, the key portion 23 is instead provided with a projection and the keyed part 3 of the fluid control valve 1 is provided with a corresponding recess to receive the projection. It is to be understood that the key portion 23 and the corresponding keyed part 3 may also conform with any suitable driver head configurations.

The body 20 of the valve key 10 is preferably of an elongated tubular form as shown in FIG. 1, with a cavity 26 for receiving the telemetry system 30. In one embodiment, the tubular body 20 comprises a hollow section configured to house the telemetry system 30 and the hollow section is coupled (for example, by way of a threaded configuration) to a cap section in use to enclose the housed telemetry system 30 therein. Preferably, the sealing connection between the hollow section and the cap section is substantially weather-resistant when in use; in other words, the sealing connection is sufficiently water proof so as to prevent water from entering the cavity/chamber in which the telemetry system 30 is housed, when closed. In one configuration, the hollow section is connected to the cavity 26. It is to be understood that the body 20 may be of any suitable shape having, for example, circular, oval, square, or any other suitable cross-sectional configurations, and the body 20 may be configured with any suitable length for use as a valve key.

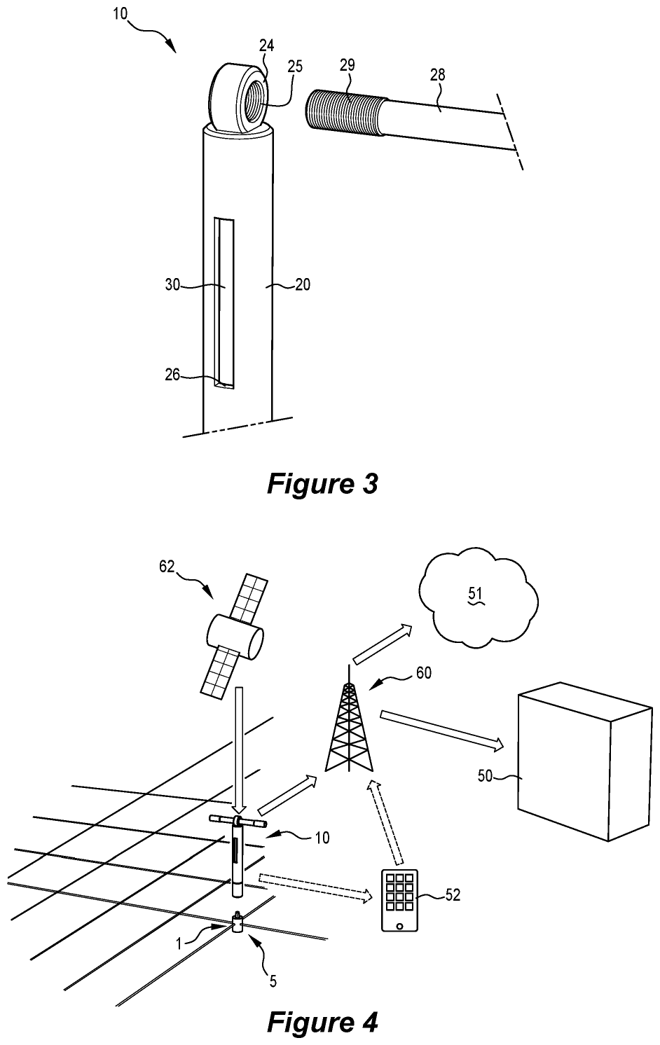

With reference to FIG. 3, the body 20 is provided at or proximate its second end 24 with a laterally-extending hollow projection 25, for example in the form of a ring, for receiving the handle bar 28. The diameter of the projection 25 is dimensioned to receive the corresponding handle bar 28 and the lateral length of the projection 25 is configured to be of sufficient length such that forces applied to the handle bar 28 when it is fully inserted through the projection 25 are effectively transmitted as such to rotate the body 20 of the valve key with respect to the longitudinal axis of the body 20. It is to be understood that the projection 25 may be of any suitable configuration to match a corresponding shape and dimension of the handle bar 28.

In the preferred embodiment, the telemetry system 30 is securely housed within the body 20 of the valve key 10. This is achieved, for example, by housing the telemetry system 30 within the cavity 26 and/or hollow section of the body 20 and closing the cavity 26 and/or closing one or both opening(s) of the hollow section. In one arrangement, the hollow section is closed by coupling to a cap section. It is to be understood that embedding the telemetry system within the body 20 of the valve key 10 includes securing/housing/locating the telemetry system 30 within the body 20 as discussed above, and does not necessary require the telemetry system 30 to be immovably mounted/soldiered to the valve key 10. Alternatively, the telemetry system 30 may be configured as a separate, portable unit attachable to the valve key 10 but not embedded within the body 20 itself. One advantage of having the telemetry system 30 as a separate modular unit is that the telemetry system 30 becomes even more portable. Having the telemetry system 30 as a separate modular unit would also allow the system to be retrofitted to valve keys that are not configured with a cavity or a hollow section to house the telemetry system 30; reducing the need to manufacture new valve keys. Moreover, since telemetry system 30 as a separate modular unit would not need to conform to the interior dimensions of a valve key, this allows the telemetry system 30 and the valve keys 10 to be designed and manufactured with greater dimensional flexibility; for example, the telemetry system 30 may be fitted with additional modular features and a larger battery and/or the valve keys 10 may be manufactured with a reduced diameter, which may lead to material savings and reduced unit weight, which in turn further improves portability and useability of the device in the field.

The telemetry system 30 comprises one or more sensors 42, 43 and a number of subsystem modules, including a location-positioning module 44 and a communications module 46, a power unit module 48, and a controller 40 configured for controlling the operation of the sensor(s) and subsystem modules of the telemetry system 30. The telemetry system comprises one or more sensors 42 mounted to the system and configured to provide digital or analogue output values to the controller 40 relating to an orientation (such as vertical or horizontal orientations) of the telemetry system 30 and also the orientation of the body 20 of the valve key 10, when the telemetry system 30 is installed (either embedded or attached to the valve key 10) and calibrated against the relative positioning of the body 20 of the valve key 10. Non-limiting examples of such sensors 42 include digital/analogue accelerometer(s), gyroscope(s) and/or barometer(s). The telemetry system 30 also comprises one or more sensors 43 configured to provide digital or analogue output values to the controller 40 relating to rotational movements (or turns) of the telemetry system 30 and, by extension, the body 20 of the valve key 10 when the telemetry system 30 is installed and calibrated. Non-limiting examples of such sensors 43 include digital/analogue accelerometer(s), gyroscope(s) and/or barometer(s). In the preferred embodiment, the sensors 42, 43 are in the form of advanced MEMS (miniature electronic mechanical sensor) which provide improved accuracy. It is to be understood that the sensors used to output parameters relating to the orientation of the telemetry 30 may be the same as sensors used to output parameters relating to the rotational movement of the telemetry system 30.

In one embodiment, the second end 24 and/or the hollow projection 25 of the valve key 10 is provided with a sensor configured for outputting parameters to the controller 40 for determining a proximity of the handle bar 28 with respect to the valve key 10 and/or a presence of the handle bar 28 through the hollow projection 25. In some configurations, the detection of the handle bar 28 when it is inserted into the hollow projection 25 of the valve key 10 triggers the controller 40 to power on components of the telemetry system 30 or to change components from a low-power state or a suspended state to a normal operational state. This advantageously allows the telemetry system 30 to operate under lower power consumption when the valve key 10 is not in use (i.e. when the handle bar 28 is not coupled to the second end 24 of the valve key 10) and thereby lead to improved power saving and longer battery standby life. This is an important feature as improving the battery standby life of the telemetry system 30 would reduce maintenance costs and improve useability of the valve key 10.

In the preferred embodiment, the location-positioning module 44 of the telemetry system 30 is configured for receiving and/or decoding data from one or more geosynchronous satellite constellations 62 to provide redundancy in location-positioning coverage from the satellite constellations and to improve time required to lock onto the minimum number of satellites required to provide the controller 40 with data relating to the geographical location of the telemetry system 30. Non-limiting examples of compatible satellite constellations could include the Global Positioning System (GPS) and the Global Navigation Satellite System (GNSS). The location-positioning module 44 is configured to be operated by the controller 40 and may also be set in a normal operational mode in which the location-positioning module 44 operates normally, a low-powered mode in which the location-positioning module 44 operates with reduced functionality with low power consumption, and a suspend mode in which the location-positioning module 44 is configured to use a minimum amount of power and does not attempt to obtain any satellite or location information; however, it would maintain sufficient power to listen for (receive and process) further instructions from the controller 40.

The communications module 46 is configured to be operated by the controller 40 for establishing a network connection with a remote server 50 (including a cloud-based network server 51) or a nearby computing device 52 for the purpose of transmitting data between the telemetry system 30 and one or more of the remote server 50, cloud-based network server 51 and/or the nearby computing device 52 (collectively, “the network devices”). The communications module 46 comprises a cellular telecommunications radio for establishing a connection with the network devices via telecommunication networks. In the preferred embodiment, the cellular telecommunications radio of the communications module 46 is capable of communicating with the Narrowband Low Power Wide Area Network (NBIoT), which reduces power required to establish and maintain radio network connections. In other embodiments, the communications module 46 may be provided with one or more radio(s) that are configured to communication over the following non-limiting example of cellular network standards, including the 2G, 3G, 4G, LTE and 5G networks. It is to be understood that data can be sent and received between the telemetry system 30 and the network devices via the connection established by the communications module 46. In the preferred embodiment, the communications module 46 is also configured to operate over a Lightweight Machine-to-Machine protocol (LWM2M).

In some embodiments, the communications module 46 is also provided with short-range radios in the form of Bluetooth®, Wi-Fi™ or any other suitable short-range communication technologies for establishing short-range wireless network connections with the nearby computing device 52 for the transmission of data between the telemetry system 30 and the computing device 52. The communications module 46 is configured to be operated by the controller 40 and may also be set in a normal operational mode in which the communications module 44 operates normally, a low-powered mode in which the communication module 44 operates with reduced functionality with low power consumption, and a suspend mode in which the communications module 44 is configured to use a minimum amount of power and does not attempt to establish any network connection, however the communications module would in the suspended mode still maintain sufficient power for receiving further instructions from the controller 40.

The power unit module 48 comprises an on-board power supply unit in the form of a battery and a power controller for providing power to the sensors 42, 43, other subsystem modules 44, 46 and the controller 40 of the telemetry system 30. In the preferred embodiment, the battery is rechargeable and replaceable from the power unit module. In some configurations, the controller 40 also serves as the power controller for regulating the battery and controlling power provided to the other components of the telemetry system 30. Power supplied to other components of the telemetry system 30 can be controlled between a normal operational state, in which power to all components are supplied as required by telemetry system 30 in the powered-on state, and a suspended power state, in which power to the components of the system are reduced, limited or turned off, so as to reduce power consumption. In some configurations, components placed in the suspended state may still maintain sufficient levels of power to monitor for instructions from the controller 40. Further description of the power control mechanism will be described in detail below.

It is to be appreciated that the telemetry system 30 is also provided with a memory module that is capable of storing telemetry system data either temporarily or permanently and making such data available to the controller 40 for processing and/or transmission to networked devices. In one embodiment, the memory module comprises solid-state storage means and/or any other suitable memory device capable of persistent data retention. In other configurations, the memory module comprises volatile data retention means such as random-access memory modules.

The controller 40 is configured to interface with and to control the sensors and the subsystem modules of the telemetry system 30, including the location-positioning module 44, the communications module 46 and the power unit module 48. The controller 40 is also configured to receive outputs from the sensors 42, 43 of the telemetry system 30 and any sensors detecting the proximity/presence of the handle bar 28 with respect to the valve key 10 to determine a physical state of the telemetry system 30 and of the valve key 10, when the telemetry system is either embedded within or attached (and calibrated) with respect to, the valve key 10 as described above. It is to be understood that in the context of the invention, the word calibrated could be taken to means the setting of the parameters of the sensors and modules of the telemetry system 30 such that they substantially correlate with, or relate to, those of the valve key 10.

The following description relates to functionality of the controller 40 when the telemetry system 30 is either embedded or attached (and calibrated) with respect to, the valve key 10. In the preferred embodiment, the controller 40 is configured to receive output from the one of more sensor(s) 42 to determine from the output an orientation of the valve key 10 (i.e. the body 20 of the valve key 10) between a substantially horizontal position (for example, when the body 20 of the valve key 10 is lying substantially horizontal on a flat surface) and a substantially vertical position (for example, when an operator raises and holds the body 20 of the valve key 10 vertically). It is to be understood that the determination of the orientation of the valve key 10 by the controller 40 may be achieved in a number of different ways—non-limiting examples include comparing data from accelerometer(s) between a present orientation of the valve key 10 and predetermined horizontal and vertical position data and allowing for a margin of error. The controller 40 is further configured to receive output from the one or more sensor(s) 43 to determine from the output a number of rotations of the valve key 10 with respect to its longitudinal axis (i.e. the number of times the body 20 of the valve key 10 is turning/rotating with respect to the longitudinal axis of the body 20). A non-limiting example of the controller 40 determining this parameter includes the controller 40 comparing data from one or more accelerometer(s) and/or gyroscope(s) to determine a relative rotational movement of the body 20 relative to its longitudinal axis. This advantageously allows the controller 40 to determine the number of times the valve key 10 has been turned with respect to the fluid control valve 1 when the valve key 10 is coupled to the fluid control valve 10 as described earlier.

The controller 40 may also be configured to receive outputs from any sensor(s) configured for detecting the proximity/presence of the handle bar 28 with respect to the valve key 10, and power on the telemetry system 30 and/or any part of the telemetry system 30 when the handle bar 28 is detected. For example, the controller 40 may power on the telemetry system 30 of the valve key 10 when a sensor provides output to the controller 40 indicating that the handle bar 28 is inserted through the hollow projection 25 (or any other suitable part of the valve key 10 so as to couple the handle bar 28 to the valve key 10 for the purpose of applying a force to turn/rotate the valve key 10). In one arrangement, the controller 40 may also power down the telemetry system 30 or any part of the telemetry system 30 when the handle bar 28 is no longer detected by the sensor(s), which indicates that the handle bar 28 has been removed or otherwise decoupled from the valve key 10.

With reference to FIG. 4, the controller 40 is connected to the communications module 46 which enables the controller 40 of the telemetry system 30 to communicate with wider computing networks. In the preferred embodiment, the controller 40 is able to access the cellular radio of the communications module to establish access to a cellular network 60, such as the Narrowband Low Power Wide Area Network. The controller may use the cellular network 60 to transmit and/or receive data from the network devices, including a remote server 50, cloud-based servers 51, or a nearby computing device 52. The data transmitted from the controller 40 to the network devices could include any one of the following non-limiting examples: local time and/or identification of the valve key 10, geographical location of the valve key 10, identification of one or more nearby fluid control valves 1, coupling status of the valve key 10 with any of the nearby control valves 1, orientation status of the valve key 10, the number of turns the valve key 10 has made with respect to a fluid control valve 1, power status of the valve key 10 and any other suitable diagnostic parameters of the valve key 10. In one configuration, the controller is able to access short-range communication radios in the form of Bluetooth, Wi-Fi or any other suitable short-range communication technologies of the communications module 46 so as to establish a suitable network connection with nearby computing devices 52 for the purpose of transmitting and/or receiving data. The short-range communication radios may also be used to establish a communications link to interact with other nearby sensors and devices, if required.

In one embodiment, the controller 40 may receive instructions from a network device, such as the remote server 50 or a nearby computing device 52. For example, the remote server 50 may, on receipt of relevant data from the controller 40 of the telemetry system 30, send instructions to the controller 40 with respect to any one of the following non-limiting functions: recording a geographical position of the valve key 10, recording a status of the valve key 10 and/or the number of turns the valve key 10 has made with respect to a nearby fluid control valve 1, transmitting information regarding the status of the nearby fluid control valve 1 to the remote server 50, and controlling the power status of the telemetry system 30. This advantageously provides the benefit of automating functions of the telemetry system 30 and the valve key 10, resulting in substantially autonomous operation and requiring few or no interaction/input from the user—this makes the valve key 10 easier to use with no extra steps, which reduces the likelihood of the unit being misused due to key steps being forgotten and omitted by a field operator.

Alternatively, the controller 40 may also be configured to interface with a nearby computing device 52 (such as a smart phone) by way of a short-range radio network, such as Wi-Fi or Bluetooth, or a cellular radio network. In this arrangement, the controller 40 may send information relating to the valve key 10 to the nearby computing device 52, and the computing device may send instructions to the controller 40 for performing operations including: recording a geographical position of the valve key 10, recording a status of the valve key 10 and/or the number of turns the valve key 10 has made with respect to a nearby fluid control valve 1, transmitting information regarding the status of the nearby fluid control valve 1 to the nearby computing device 52, and controlling the power status of the telemetry system 30. In one embodiment, the nearby computing device 52 may be provided with application-specific software for connecting with, and controlling, the telemetry system 30. In this regard, the software could be used by a field operator for the following non-limiting functions: to power on the telemetry system 30, record and observe statuses of the valve key 10, record and observe geographical locations of the valve key 10, record and observe nearby fluid control valves, initiate recording of the rotational movement of the valve key 10 when the valve key 10 is operatively coupled with a keyed part 3 of the fluid control valve 1 and recording the status of the fluid control valve 1, controlling the power states of the telemetry system 30 and transmitting relevant data regarding the status of the telemetry system 30, valve control key 10 and the fluid control valve 1 to a remove server 50 and/or storing the data on the local storage means of the nearby computing device 52.

It is to be understood that a remote server 50, such as a web server, may also be configured to allow an operator to interface with and control the valve key 10 in a manner that is similar to the functions of the nearby computing device 52. In one embodiment, the communication module 46 of the telemetry system 30 is configured with a software client that is compatible with the Lightweight Machine-to-Machine (LWM2M) protocol, which is a light and compact protocol for the transmission of data and management of telemetry system 30 over cellular networks.

The controller 40 is also configured to receive satellite location data from the location-positioning module 44 and to determine the geographical location of the telemetry system 30 and, by extension, the location of the valve key 10. In some arrangements, the controller 40 is able to interface with the location-positioning module 44 and to determine the most suitable satellite network for achieving a quick positioning lock. Information regarding the geographical positioning of the valve key 10 is communicated to network devices as described earlier. In one embodiment, the controller 40 transmits information relating to the geographical location of the valve key 10 to one or more network devices and, in return, the controller 40 is provided with identification information relating to nearby fluid control valves 1.

One problem with conventional valve keys fitted with electronic sensors is poor power management and premature depletion of power if batteries are not deactivated properly after each use, which would have the undesirable effect of having a non-functioning valve key with unpowered electronic sensors when its use is needed in the field. In this respect, the controller 40 is configured to either (1) control the power supplied to each of the sensor(s) and each one of the subsystem modules of the telemetry system 30 and/or (2) control each of the sensor(s) and each one of the subsystem modules directly to adjust the level of power used by each component. In the preferred embodiment, the controller 40 is configured to adjust the power consumed by each sensor and subsystem module of the telemetry system 30 between a number of operating modes, including (1) a normal operating state, in which the component under control is fully powered and functional so that the telemetry system modules and the controller 40 are configured to record the number of rotations of the valve key 10, (2) a low-power state, in which power supplied to the components of the telemetry system 30 is reduced to save power. It is to be understood that even in the low-power state, power is still provided to certain components to maintain operability; for example, a minimal level of power is provided to the controller and to the one of more sensors to detect power-on conditions.

In the preferred embodiment, the controller 40 of the telemetry system 30 is configured to determine from outputs of the one or more sensors (for example, sensors 42, 43) an orientation of the valve key 10 (by determining an orientation of the body 20 of the associated valve key 10) between a substantially horizontal position and a substantially vertical position. The controller is configured to set components of the telemetry system 30 to a low-powered state as discussed above when the body 20 is determined to be in the substantially horizontal position. The substantially horizontal position resembles the resting position of the valve key 10 (for example, when the valve key 10 lies on a substantially surface), and the controller reduces power, by means discussed above, to the telemetry system 30 to improve longevity of the on-board battery/power module of the telemetry system 30. In addition, the controller is configured to set components of the telemetry system 30 to the normal operating state so that the system is able to record the number of rotations of the valve key 10 with respect to a coupled fluid control valve 1 when the body 20 is determined to be in the substantially vertical position. The substantially vertical position resembles the position in which the valve key 10 takes when a field operator picks up the valve key 10 and readies the valve key 10 for use with a fluid control valve 1. This automatic detection of the orientational state of the body 20 (and valve key 10) and automatic adjustments to the power states of the telemetry system 30 advantageously allow the valve key 10 to be operated autonomously with little to no user input—thereby reducing the number of steps that would need to be taken by the user to active and use the valve key 10, which would lead to improved useability and reliability of the valve key 10 in performing its intended functions.

In the preferred embodiment, the telemetry system 30 also comprises a display module 49 configured for displaying relevant data and metrics to a field operator. Information conveyed by the display module 49 could include any one or more of the following non-limiting examples: operational and/or power states of the valve key 10, network connectivity status of the telemetry system 30, diagnostic metrics of the telemetry system 30 (such as power levels, battery levels, storage levels, satellite locking status, and any additional network connection metrics), geographical location of the valve key 10, orientation status of the valve key 10, connection status of the handle bar 28 with respect to the body 20 of the valve key 10, identification and information with respect to any one or more nearby fluid control valves 1, coupling status with a fluid control valve 1, the number of clockwise or anti-clockwise rotational turns of the valve key 10 recorded against the fluid control valve 1, and the operational status of the fluid control valve 1. It is to be understood that the display module 49 may comprise any suitable display component, such as liquid crystal display (LCD), light-emitting diode (LED), and any other suitable display technologies. In the preferred embodiment, outputs to the display module 49 is generated and/or controlled by the controller 40.

With reference to FIGS. 1 to 4, in the preferred embodiment, the valve key 10 (with the telemetry system 30 either embedded or attached (and calibrated) as described above) is in a low-power state when the body 20 is stored in a substantially horizontal orientation. In use, a field operator would carry the valve key 10 to a field destination close to a fluid control valve 1 and ready the valve key 10 for use by holding the body 20 of the valve key 10 in a substantially vertical orientation; this orientation is detected autonomously by the telemetry system 30 of the valve key 10 and components of the telemetry system 30 are powered in a normal operating state. The field operator would then assembly the valve key 10 for use by coupling the handle bar 28 with the body 20 of the valve key 10 and subsequently coupling the key portion 22 of the valve key 10 to a keyed part 3 of a corresponding fluid control valve 1. In the preferred embodiment, once in the operating state, the telemetry system 30 of the valve key 10 would be able to establish a network connection by using its one or more cellular radio(s) and lock onto geosynchronous satellite constellations to determine a relative geographical position of the valve key 10. The telemetry system 30 is also capable of matching its geographical position with a database of known locations of fluid control valves 1 and determining the identification and operational statuses (for example, open, partially open or closed) of any one or more nearby fluid control valves 1 and/or the fluid control valve 1 (closest by distance) to be operated by the valve key 10. Using information relating to the operational status of the fluid control valve 1, the valve key 10 will record new rotational movements of the valve key 10 with respect to the operated fluid control valve 1 and record the new operational status of the fluid control valve 1 (for example, open, partially open or closed). Information relating to the number of rotations of the valve key 10 with respect to the fluid control valve 1 and/or the operational status of the operated fluid control valve 1 is autonomously transmitted by the telemetry system 30 to a remote server 50, a cloud-based server 51 or a nearby computing device 52 (the network devices). This transmission can be done in real-time. Once the field operator has completed the task of using the valve key 10 to adjust the operational statuses of the fluid control valve 1, the valve is then disassembled and stored in a horizontal orientation, at which point the telemetry of the valve key 10 will complete any data transmission to the network devices and then proceed to enter a low-power mode. In this scenario, the field operator is not required to provide specific instructions to the telemetry system 30 of the valve key 10 and thereby making the valve key and the status recordal process highly user-friendly and reducing the risk of operational errors.

It is to be understood that while the autonomous use scenario has been described, it is also possible in other embodiments to use the telemetry system 30 and the valve key 10 in a more interactive manner—such as having the field operator (or a remote operator at a remote server) initiate the telemetry system 30 functions manually (for example, this may be achieved with an application-specific software installed on the nearby computing device 52). The data collected in the remote server or cloud-based server can be utilised in various ways by the utilities company. For example, the data may be used to update fluid control valve 1 status fields in real-time across a network of such valves 1. It may also be used to automatically audit contractors on which valve(s) 1 have been operated correctly. Furthermore, it may be used to interrogate the operating status and/or condition of a fluid control valve, for example, as indicated by the number of valve key 10 turns to open/close the valve.

In the description and drawings of this embodiment, same reference numerals are used as have been used in respect of the first embodiment, to denote and refer to corresponding features.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

What is claimed is:

1. A valve key for operating a fluid control valve between open and closed states, the valve key comprising:
a body having a key portion configured for operating a correspondingly keyed part of the fluid control valve;
a telemetry system operatively coupled to the body, the telemetry system comprising one or more sensors configured to output parameters relating to an orientation and a rotational movement of the body; a location-positioning module configured to receive data from global positioning satellites; a communications module for transmitting data to a remote server; and a controller configured to determine an orientation of the key between a substantially horizontal position and a substantially vertical position, a number of rotations of the key with respect to its longitudinal axis when the key portion is coupled to the fluid control valve and geographical coordinates relating to a location of the key from the output parameters and the satellite data,
wherein the controller is configured such that the telemetry system is set to a low-power state when the body is oriented in a substantially horizontal position, and set to an operating state, in which the telemetry system modules and the controller are configured to record the number of rotations of the key, when the body is oriented in a substantially vertical position.

2. A valve key according to claim 1, wherein the telemetry system is configured to be a standalone module that is removable from the body.

3. A valve key according to claim 1, further comprising a detachable handle bar configured to be slideably receivable in a corresponding cavity located at an end opposing an end associated with the key portion of the body.

4. A valve key according to claim 3, wherein the cavity is provided with a sensor configured to output parameters relating to a presence of the handle bar relative to the cavity, and wherein the controller is configured to determine the presence of the handle bar in the cavity from the output parameters of said sensor and set the telemetry system to the operating state when the handle bar is received within the cavity.

5. A valve key according to claim 1, wherein the telemetry system further comprises a storage module for retaining data relating to the number of rotations of the key with respect to its longitudinal axis and the geographical coordinates of the key.

6. A valve key according to claim 1, wherein the controller is configured to operate the communications module to send data relating to the number of rotations of the key with respect to its longitudinal axis and the geographical coordinates of the key to a remote server.

7. A valve key according to claim 6, wherein the controller is configured to operate the communications module to send said data relating to the number of rotations of the key with respect to its longitudinal axis and the geographical coordinates of the key when the body is oriented in a substantially horizontal position and the communications module is placed in a low-powered mode once data transmission to the remote server is complete.

8. A valve key according to claim 6, wherein the controller is configured to output said data to a local computing device.

9. A valve key according to claim 1, wherein the controller is configured to start determining the number of rotations of the key with respect to its longitudinal axis when the controller receives instructions from a remote server.

10. A valve key according to claim 1, wherein the controller is configured to start determining the number of rotations of the key with respect to its longitudinal axis when the controller receives instructions from a local computing device.

11. A valve key according to claim 1, wherein the controller is configured to start determining the number of rotations of the key with respect to its longitudinal axis when a sensor detects that the key portion is engaged with a receiving portion of a fluid control valve.

12. A valve key according to claim 1, wherein the controller is configured to retrieve a previously recorded status of a fluid control valve from a remote server based on comparing the geographical coordinates relating to the location of the key with a database of geographical coordinates of fluid control valves within a network.

13. A valve key according to claim 1, wherein the controller is configured to retrieve a previously recorded status of a fluid control valve from a local computing device based on the geographical coordinates relating to the location of the key.

14. A valve key according to claim 1, wherein the sensor configured to output parameters relating to the rotational movement of the body is also placed in a low-powered mode when the telemetry system is set to a suspended state.

15. (canceled)

16. A valve key according to claim 1, wherein the communications module comprises a Narrowband Low Power Wide Area Network (NBIoT) cellular telecommunications radio.

17. A valve key according to claim 1, wherein the communications module is configured to operate over a Lightweight Machine-to-Machine (LWM2M) protocol.

18. A valve key according to claim 1, wherein the location-positioning module is configured to receive data from multiple global positioning satellite constellations.

19-20. (canceled)

21. A valve key according to claim 1, wherein the telemetry system is embedded in the body of the valve key.

22. A valve key according to claim 1, wherein the telemetry system is further provided with a display unit configured for displaying information relating to any one of the following non-limiting outputs:
(1) name and status of a fluid control valve,
(2) geographical location of the key,
(3) a number of rotations of the key with respect to its longitudinal axis when the key portion is coupled to the fluid control valve, and
(4) connection status with respect to a local computing device or a remote server.

23. (canceled)

24. A system for managing the status of a fluid control valve which is configurable between open and closed states, comprising a valve key according to claim 1 and a remote server configured to receive information from the telemetry system of the valve key relating to a geographical location of the key and a number of rotations of the key with respect to its longitudinal axis when the key portion is coupled to the fluid control valve, and storing said information in a database against a record for said fluid control valve which is retrievable by the valve key when positioned in proximity to the fluid control valve.
